(19) United States
(12) Patent Application Publication
(10) Pub. No.: US 2004/0046438 A1
(43) Pub. Date: Mar. 11, 2004

(54) Tricycle with movable storage bin

(76) Inventors: Stephen A. Stickel, Columbus, IN (US); Joseph Baumgartner, Carmel, IN (US); Michael Dorsey, Brownsburg, IN (US)

Correspondence Address: BARNES & THORNBURG, 11 SOUTH MERIDIAN, INDIANAPOLIS, IN, 46204

(21) Appl. No.: 10/235,372

(22) Filed: Sep. 5, 2002

(51) Int. Cl. B60P 1/04

(52) U.S. Cl. 298/17 R

(57) ABSTRACT

A wheeled child's vehicle includes a frame, a front wheel coupled to the frame, a rear wheel mount having opposite ends, a rear wheel rotatably coupled adjacent each end, and a movable storage bin coupled to the frame adjacent the rear wheels.

### BACKGROUND AND SUMMARY

The present disclosure relates to a child's ride-on vehicle and particularly to such a vehicle having a movable storage bin. More particularly, the present disclosure relates to a tricycle having a movable storage bin.

Children's wheeled ride-on vehicles, such as tricycles and the like, are known and frequently have additional features to entertain their users. Children are often entertained by simulating various adult activities, such as work activities and the like.

According to the present disclosure, a child's ride-on vehicle comprises a frame, a plurality of wheels coupled to the frame, a seat coupled to the frame, and a storage bin. The storage bin is coupled to the frame and is movable between a storage orientation and a dumping orientation. A releasable latch is coupled between the frame and storage bin to inhibit movement of the storage bin from the storage orientation to the dumping orientation.

In the illustrated embodiment, the storage bin comprises a bottom having an upwardly-facing surface, an opposite surface, and an upstanding wall extending from the bottom to form a receptacle. A bracket is coupled to the opposite surface of the bottom and is pivotally coupled to the frame.

The frame includes a rear frame member and the bracket engages the rear frame member and pivots about the rear frame member as the storage bin moves between the storage orientation and the dumping orientation. The latch includes an actuator movably coupled to the wall. The actuator has a first surface that engages a second surface provided on the frame to releasably maintain the storage bin in the storage orientation. The actuator is pivotally coupled to the wall to move between a latched position in which the first surface is positioned to engage the second surface and a released position in which the first surface is disengaged from the second surface as the storage bin is moved from the storage orientation to the dumping orientation.

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a tricycle including a frame, a front wheel, a pair of rear wheels, a seat coupled to the frame, and a movable storage bin shown in a storage orientation;

FIG. 2 is a perspective view of the tricycle of FIG. 1 showing the storage bin pivoted to a dumping orientation, and a portion of the seat broken away to reveal a latch for securing the storage bin in the storage orientation shown in FIG. 1;

FIG. 3 is a fragmentary sectional side view, taken generally along line 3-3 of FIG. 1, showing a latch (comprising an actuator and a catch) in a latched orientation so that the catch is positioned to lie in the path of an “engagement surface” of the actuator to block movement of the storage bin away from the storage position in the manner shown in FIG. 4;

FIG. 4 is a fragmentary side view of the tricycle similar to FIG. 3, showing a user attempting to lift a “latched” storage bin while the latch inhibits movement of the storage bin from the storage orientation to the dumping orientation owing to contact between the engagement surface of the actuator and a catch surface of the catch;

FIGS. 5-7 show a sequence wherein a user operates the actuator to “release” the latch coupling the storage bin to the tricycle frame and then moves the storage bin relative to the tricycle frame to the dumping orientation;

FIG. 5 is a fragmentary partial sectional view taken generally along line 5-5 of FIGS. 1 and 12, showing a section of the latch and a bracket extending from a floor of the storage bin and coupling the storage bin to the tricycle frame to pivot relative to the frame;

FIG. 6 is a fragmentary sectional side view similar to FIG. 4 showing a user lifting a handle to actuate the actuator and move it to a released position so the storage bin may be moved from the storage orientation;

FIG. 7 is a fragmentary sectional view similar to FIG. 6, showing the storage bin in a dumping orientation, an outer surface of the rear wall of the storage bin forming an acute angle with the surface on which the tricycle rests, and a user pulling on a handle of the actuator to move the storage bin toward the storage orientation;

FIGS. 8-10 show a sequence showing installation of the actuator in a recess formed in the storage bin to allow for pivotable movement of the actuator about a pivot axis relative to the storage bin;

FIG. 8 is a fragmentary, exploded sectional view (similar to FIG. 10) showing the actuator prior to insertion between a pair of inwardly-facing walls bordering a recess formed in a front wall of the storage bin;

FIG. 9 is a fragmentary sectional view similar to FIG. 8 showing each end of a shaft of the actuator flexing a tab that borders an opening formed in each of the inwardly-facing walls;

FIG. 10 is a fragmentary sectional view similar to FIG. 9 and taken along line 10-10 of FIG. 2 showing the actuator assembled so the ends of the shaft are situated in the openings in the inwardly-facing walls to mount the actuator pivotally relative to the storage bin;

FIG. 11 is a fragmentary exploded perspective view of a portion of the tricycle showing a bracket extending from the bottom surface of the storage bin floor and a collar positioned on the other side of a frame member (illustrated in phantom) to pivotally couple the storage bin to the frame;

FIG. 12 is a rear view of the tricycle showing the brackets and collars coupled together and wrapping around the rear frame member;

FIG. 13 is a fragmentary bottom view of the tricycle with a portion of the frame broken away to expose the actuator in the recess in the front wall of the storage bin, and the collars coupled to the brackets to pivotally couple the storage bin to the frame; and

FIG. 14 is a perspective view of the actuator with a handle removed from the end of one of the levers showing the end of the actuator shaft spaced apart from the opening and the tab bordering the opening of a portion of one of the interior walls of the front wall of the storage bin.

### DETAILED DESCRIPTION

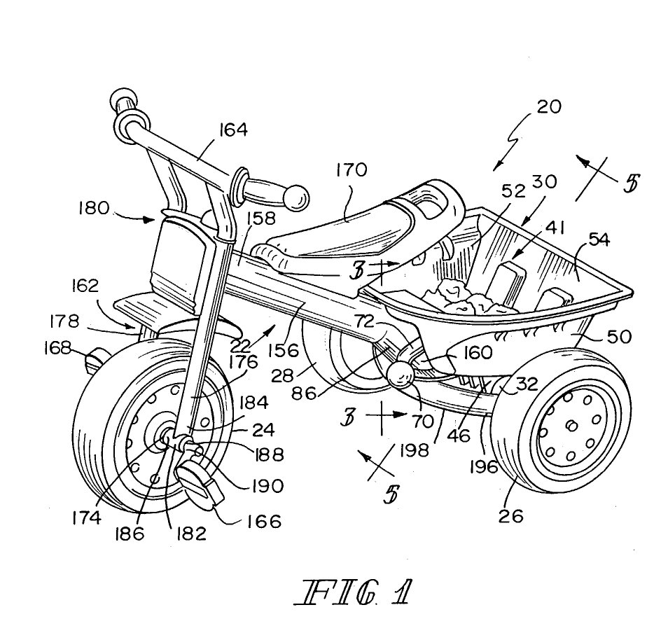

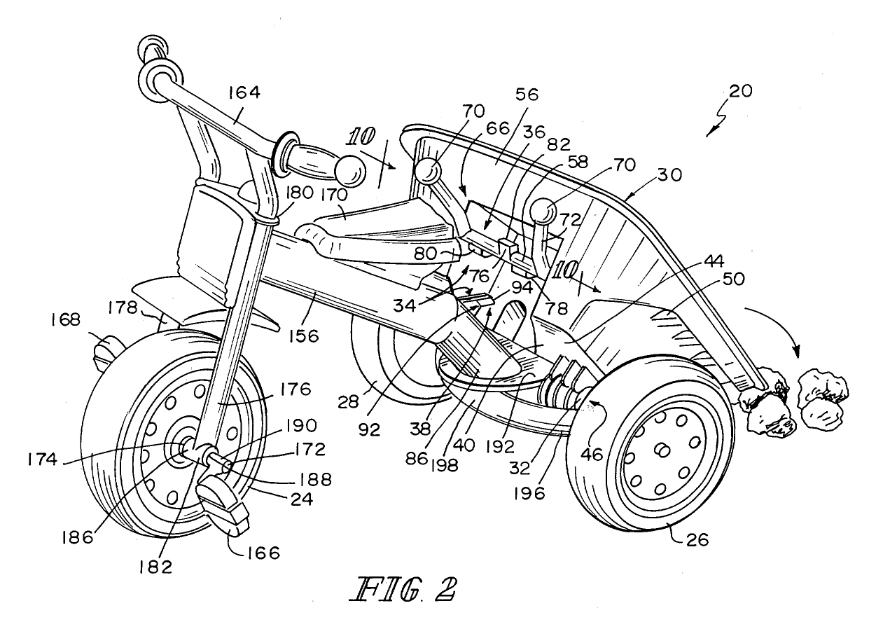

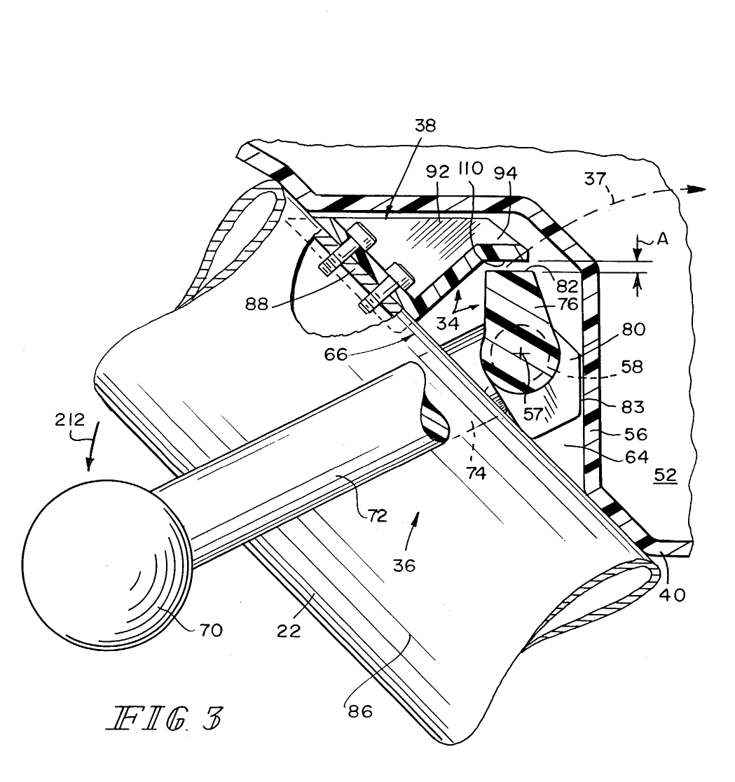

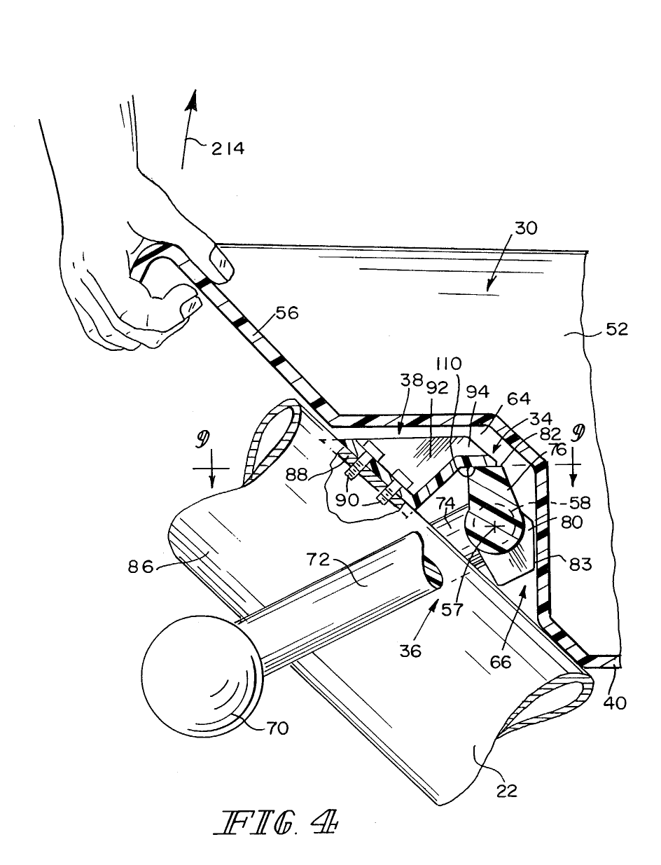

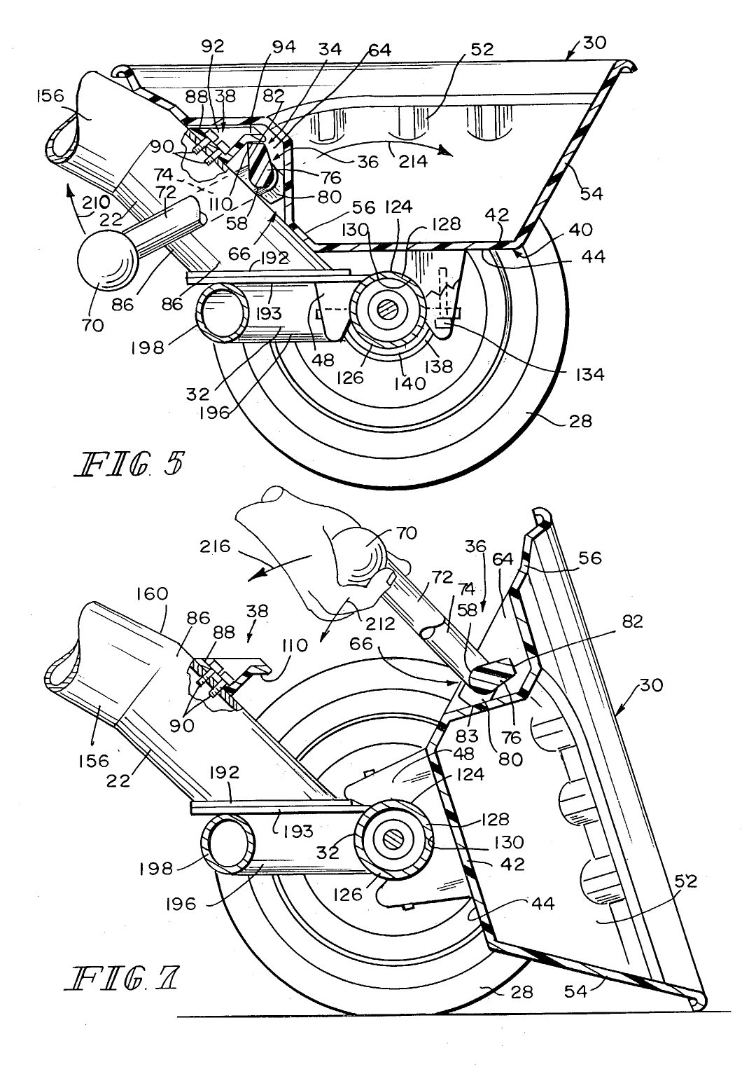

As shown in FIG. 1, a tricycle 20 includes a frame 22, a front wheel 24, and left and right rear wheels 26, 28 all rotatably coupled to frame 22. A storage bin 30 is coupled to frame 22, illustratively to rear wheel mount 32. Storage bin 30 pivots relative to frame 22 between a storage orientation shown in FIG. 1 and a dumping orientation shown in FIG. 2. As shown in FIGS. 2 and 4, a latch 34 is coupled to tricycle frame 22 and storage bin 30 to releasably lock storage bin 30 in the storage orientation and provide means for latching the storage bin 30 in a storage orientation to inhibit movement of storage bin 30 from the storage orientation toward a dumping orientation. Latch 34 includes an actuator 36 pivotally coupled to storage bin 30 and a catch or catch portion 38 coupled to frame 22 as shown best in FIG. 4. To move storage bin 30 from the storage orientation, a user “actuates” actuator 36 as illustrated in FIG. 6, moving it from alignment with catch portion 38 so that catch portion 38 does not engage actuator 36 and block movement of storage bin 30 to the dumping orientation.

Storage bin 30 includes a floor 40 and walls 50, 52, 54, 56 extending upwardly from floor 40 to form a receptacle 41 for receiving objects. Actuator 36 is pivotally coupled to front wall 56, and part of actuator 36 is situated in a recess 66 formed in front wall 56. Left and right side walls 50, 52 of storage bin 30 extend generally upwardly from floor 40 and are spaced apart from each other. Rear wall 54 and front wall 56 are coupled to and extend between left and right side walls 50, 52. Floor 40 includes an upwardly-facing surface 42 and an opposite, downwardly-facing surface 44. Brackets 46, 48 are coupled to and extend from downwardly-facing surface 44 and engage frame 22 to permit a user to move the storage bin 30 between the storage and dumping orientations.

Actuator 36 moves relative to storage bin 30 so that actuator 36 pivots from a normal or latched position shown in FIG. 3 to an actuated or released position shown in FIG. 5. When latch 34 is in the latched position, catch 38 lies in the latched path 37 of an engagement surface 82 of actuator 36, as shown in FIG. 3, blocking movement of engagement surface 82 beyond catch 38. In the released position shown in FIG. 6, catch 38 is out of the unlatched path 39 of engagement surface 82 of actuator 36, no longer blocking movement of actuator 36, permitting a user to move storage bin 30 to the dumping orientation.

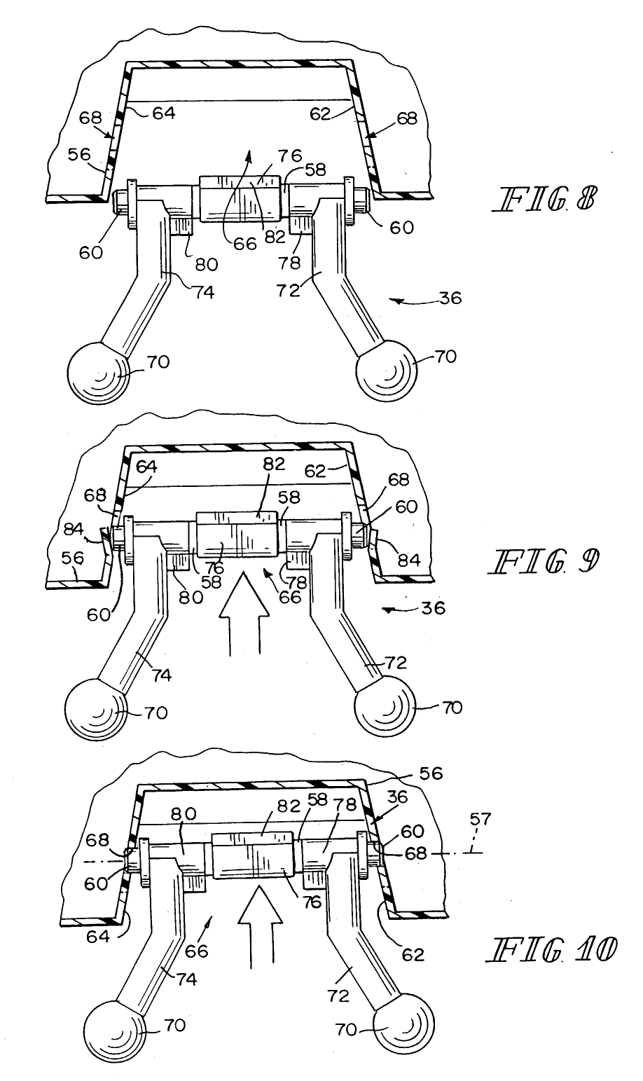

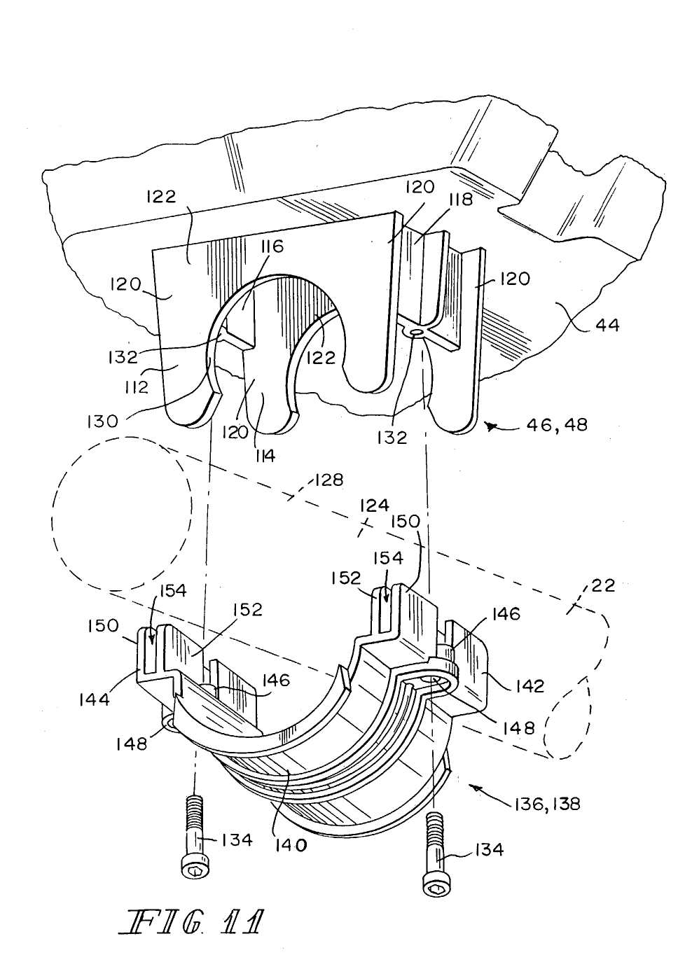

As shown in FIG. 10, actuator 36 is coupled to front wall 56 for movement between the latched and released positions about an axis 57. As shown in FIGS. 2-10, actuator 36 includes a shaft 58 that couples actuator 36 adjacent ends 60 thereof to interior walls 62, 64 that border recess 66 in front wall 56 of storage bin 30. As shown in FIGS. 9-11 and 15, ends 60 are inserted into openings 68 formed in walls 62, 64, and pivot therein as a user pivots the actuator 36 relative to storage bin 30. To actuate actuator 36, a user pivots actuator 36 about axis 57, as shown in FIG. 6, lifting in direction 210 one of a pair of handles 70 coupled to an end of one of a pair of levers 72, 74 that extend from shaft 58. When the user releases handle 70, the weight of levers 72, 74 and handles 70 pivot actuator 36 about axis 57 in direction 212 to the latched position shown in FIG. 3.

Actuator 36 includes a first lobe 76 which, when actuator 36 is in the latched position shown in FIG. 4, cooperates with catch portion 38 to latch storage bin 30 in the storage orientation. As illustrated in FIGS. 2-10, first lobe 76 is coupled to shaft 58, illustratively to the center of shaft 58. First lobe 76 includes an engagement surface 82 positioned to engage catch portion 38 to prevent undesired movement of storage bin 30 from its storage orientation. As shown in FIG. 4, when actuator 36 is in the latching orientation, and a user attempts to lift storage bin 30 in direction 214, engagement surface 82 engages catch portion 38 to inhibit movement of storage bin 30 from the storage orientation.

First lobe 76 and outer lobes 78, 80 cooperate with front wall 56 to prevent over-rotation of latch 36 beyond the latched and released orientations shown in FIGS. 3 and 5 respectively. Outer lobes 78, 80 are coupled to shaft 58, illustratively on each side of first lobe 76. In the latched orientation of actuator 36, first lobe 76 lies between front wall 56 and frame 22. Outer lobes 78, 80 each have an engagement surface 83 that engages front wall 56, as shown in FIG. 5, when actuator 36 is moved to the latched orientation to prevent over-rotation of actuator 36 in direction 212 beyond the latched orientation. As shown in FIG. 6, first lobe 76 engages front wall 56, to prevent over-rotation of actuator 36 in direction 210 beyond the released orientation.

As shown in FIG. 3, in the latched orientation of actuator 36, engagement surface 82 of actuator 36 and catch surface 110 of catch portion 38 are positioned relative to one another so that engagement surface 82 clears catch surface 110 when actuator 36 is pivoted between the latched orientation and the released orientation. As shown in FIG. 3, engagement surface 82 and catch surface 110 are normally spaced apart and illustratively lie generally facing and parallel to one another. In this orientation, engagement surface 82 and catch surface 110 are spaced apart by a distance A. Distance A is sufficient to permit a user to pivot actuator 36 in direction 210 about axis 57 to the released orientation shown in FIG. 6 so that storage bin 30 can be lifted in direction 214 toward the dumping orientation. As shown in FIGS. 3 and 4, catch surface 110 lies in the path of engagement surface 82 when actuator 36 is not actuated. As shown in FIG. 4, as a user lifts storage bin 30 in direction 214, engagement surface 82 and catch surface 110 engage one another, and further movement of storage bin 30 in direction 214 is inhibited.

To actuate actuator 36, a user grasps either or both of handles 70 and pivots the actuator 36 in direction 210 from the latched orientation shown in FIGS. 3, 4, and 6 to the released orientation shown in FIG. 6. This movement moves first lobe 76 so that catch surface 110 is not in the path of engagement surface 82, releasing storage bin 30 to be moved in direction 214 to the dumping orientation shown in FIG. 7.

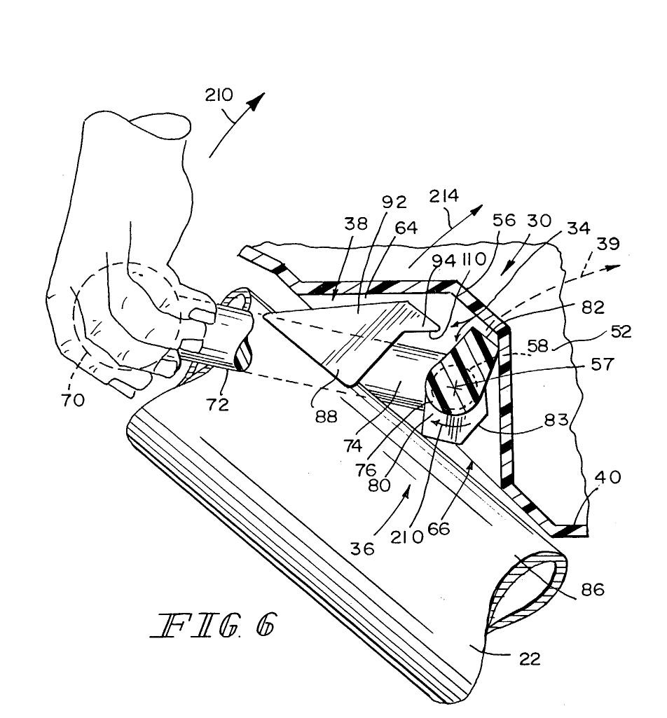

As shown in FIGS. 8-10, actuator 36 is assembled by coupling actuator 36 to storage bin 30 at a recess 66 in front wall 56. Interior walls 62, 64 of front wall 56 are generally opposing and inwardly-facing. Interior walls 62, 64 each have openings 68 therein sized to receive ends 60 of shaft 58, as shown in FIG. 14. To facilitate insertion of ends 60 into openings 68, a flexible tab 84 extends into each opening 68. As shown in FIGS. 9-11, when assembling actuator 36 to storage bin 30, a user inserts shaft 58 into recess 66, sliding ends 60 of shaft 58 over tabs 84 and into openings 68 in interior walls 62, 64. Illustratively, ends of tabs 84 cooperate with openings 68 to approximate the annular shape of ends 60 and permit actuator 36 to pivot relative to interior walls 62, 64 and maintain the position of ends 60 therein. When assembled, as shown in FIG. 6, actuator 36 is positioned forward of brackets 46, 48.

Catch portion 38 of latch 34 extends from frame extension 86 to face front wall 56 and recess 66. Catch portion 38 includes a base 88 to mate with frame extension 86. Aligned holes in base 88 and frame extension 86 receive retainers 90 therethrough to couple catch portion 38 to frame 22. A wall 92 extends from base 88, illustratively extending perpendicularly from frame extension 86. Wall 92 includes a rearwardly-extending lip 94.

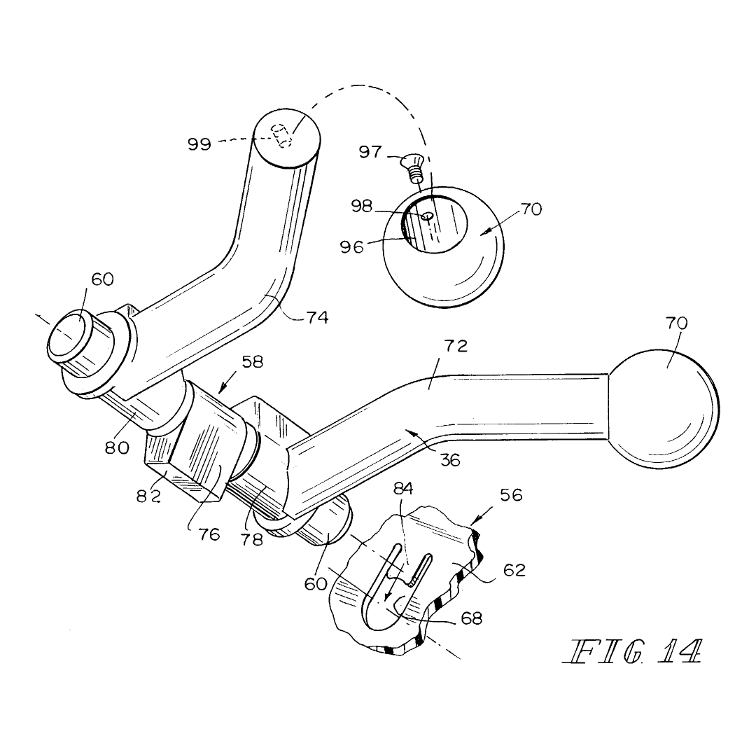

As shown in FIGS. 2, 8-10, 13 and 14, one end of each of left and right levers 72, 74 is coupled to and projects from each end of shaft 58. The other end of each of levers 72, 74 is provided with one handle 70. The other end of each of left and right levers 72, 74 extends toward a front portion of tricycle 20 and outwardly from a longitudinal centerline through tricycle 20 so that handles 70 are accessible from either side of frame 22 and in front of storage bin 30.

Illustratively, each handle 70 is ball-shaped and includes a lever-receiving aperture 96 to receive lever 72, 74. A handle screw hole 98 extends through handle 70 to lever-receiving aperture 96 and aligns with a hole 99 in the protruding end of lever 72, 74. A retainer 97 is inserted through holes 98, 99 to secure handle 70 to lever 72, 74. While retainer 97 is illustratively a screw, a wide variety of connectors such as pins, nuts and bolts, rods, and the like may be used in accordance with the present invention. As best shown in FIGS. 2 and 14, when actuator 36 is coupled to storage bin 30, each lever 72, 74 extends toward the front of tricycle 20 and away from the other lever 72.

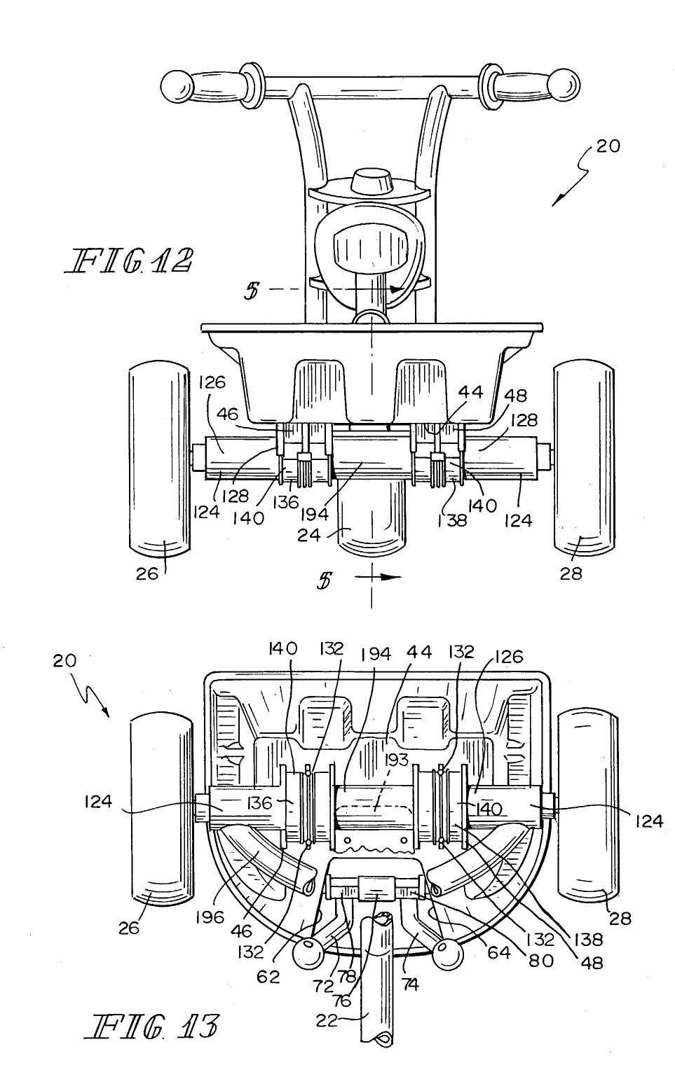

As shown in FIGS. 12-14, first and second brackets 46, 48 pivotally couple storage bin 30 to frame 22. Brackets 46, 48 are coupled to downwardly-facing surface 44. As best shown in FIG. 12, each of brackets 46, 48 include a pair of spaced walls 112, 114 extending from downwardly-facing surface 44. First and second panels 116, 118 extend between walls 112, 114 at ends 120 of each wall. Ends 120 of walls 112, 114 project from downwardly-facing surface 44 a greater distance than a central portion 122 of each wall 112, 114. Central portion 122 is complementarily shaped to outer portions 124 of rear frame member 126. Illustratively, outer portions 124 have generally right circular cylindrical regions 128, and central portion 122 of each of walls 112, 114 of each of first and second brackets 46, 48 include a part-circular bearing surface 130 to slide against the regions 128 of outer portions 124. First and second panels 116, 118 each include a boss 132 having an aperture therein to receive a retainer 134 as described below. Illustratively, as shown in FIG. 5, bearing surfaces 130 of brackets 46, 48 are disposed approximately centrally on floor 40. Thus, storage bin 30 is generally centered over its pivot axis, illustratively the centerline through rear frame member 126.

As shown in FIGS. 5 and 12-14, tricycle 20 includes first and second collars 136, 138 to couple to first and second brackets 46, 48 respectively and pivotally couple storage bin 30 to rear frame member 126. Each of collars 136, 138 include a body 140 that is illustratively part right circular cylindrical in shape. As shown in FIG. 12, body 140 includes a first side 142 and an opposite second side 144. A coupler 146 is provided on each of sides 142, 144, the coupler illustratively including a hole 148 for receiving a retainer 134 therethrough. While the retainer 134 is illustratively a screw, a wide variety of connectors such as pins, rivets, rods, clips, nuts and bolts, and other suitable connectors may be used in accordance with the present disclosure. A pair of walls 150, 152 having a gap 154 for receiving a panel 116 or 118 are provided on each coupler 146.

Storage bin 30 is coupled to frame 22 by positioning bearing surfaces 130 of brackets 46, 48 on regions 128. Collars 136, 138 are then attached to brackets 46, 48 respectively, thus pivotally coupling storage bin 30 to frame 22. In the storage orientation shown in FIGS. 1 and 5, storage bin 30 is supported by rear frame member 126 contacting brackets 46, 48, and, as also shown in FIG. 7, by a main frame member 156 of frame 22 contacting front wall 56.

As shown in FIGS. 1 and 2, frame 22 includes main frame member 156 having a front portion 158 and a rear portion 160. A fork 162 is pivotally coupled to front portion 158 of main frame member 156. Front wheel 24 is rotatably mounted adjacent a lower end of fork 162 and a handlebar 164 is mounted adjacent an upper end for steering the tricycle. A seat 170 is coupled to frame 22. Left and right pedals 166, 168 are coupled to a crank 172 attached at 174 to front wheel 24. Rear wheel mount 32 is coupled to main frame member 156.

As shown in FIG. 1, front portion 158 of main frame member 156 is coupled to fork 162. Fork 162 includes a pair of generally parallel fork members 176, 178. Fork members 176, 178 are coupled to each other adjacent upper end 180 by handlebar 164. A wheel mount 182 is coupled to fork 162 adjacent lower end 184. Wheel mount 182 includes left and right wheel connectors 186 having a fork connection portion (not shown) received in an opening in lower end 184 of one of fork members 176, 178. Each wheel connector 186 includes a bearing 188 to receive an associated one of left and right journals 190 of crank 172 for rotation of crank 172 in wheel mount 182. When pedals 166, 168 are operated by a user, crank 172 rotates in bearings 188, and rotates the front wheel 24 to power tricycle 20.

Illustratively, as shown in FIG. 5, an inner surface of rear wall 54 forms an obtuse angle with floor 40. An outer surface of rear wall 54 forms an acute angle with the surface on which tricycle 20 is supported when storage bin 30 is in the dumping orientation, articles contained in bin 30 can slide down rear wall 54 and out of bin 30.

As shown in FIGS. 5 and 6, tricycle 20 includes a first connector plate 192 coupled to frame extension 86. Extension 86 extends from rear portion 160 of main frame member 156 and toward rear wheels 26, 28. Wheel mount 32 illustratively includes rear frame member 126 having a central portion 194 and outer portions 124. A somewhat C-shaped front frame member 196 is coupled at its ends to the outer portions 124 of rear frame member 126. A central portion 198 of front frame member 196 extends toward the front wheel 24. A second connector plate 193 is coupled to central portion 198 of front frame member 196 extending toward and coupled to central portion 194 of rear frame member 126. First and second connector plates 192, 193 are coupled to frame 22 and together by any suitable method, for example by welding, coupling the plates to the frame or to each other with nuts and bolts, clips, retainers, and the like.

Although the illustrative embodiment shows a tricycle, it is within the scope of this disclosure to include the features disclosed herein with a child's vehicle having any number of wheels. Although the disclosure has been described in detail with reference to certain illustrative features or embodiments, variations and modifications exist within the scope and spirit of the disclosure as shown and described.

1. A child's vehicle comprising a frame, a seat coupled to the frame, wheels rotatably coupled to the frame, a storage bin pivotally coupled to the frame to move between a storage orientation and a dumping orientation, and a latch coupled between the frame and the storage bin and adapted to inhibit movement of the storage bin from the storage orientation.

2. The child's vehicle of claim 1, wherein the latch comprises an actuator coupled to one of the frame and the storage bin, the actuator being movable between a first orientation inhibiting relative movement between the storage bin and frame and a second orientation permitting relative movement between the storage bin and frame.

3. The child's vehicle of claim 1, wherein the latch comprises an actuator coupled to one of the frame and the storage bin and a catch coupled to the other of the frame and the storage bin, the actuator being movable between a first orientation engaging the catch and inhibiting relative movement between the storage bin and frame and a second orientation releasing the catch and permitting relative movement between the storage bin and frame.

4. The child's vehicle of claim 1, wherein the latch includes a first surface that moves with the storage bin in a first path about a portion of the frame upon movement of the storage bin between the storage orientation and dumping orientation, and a second surface coupled to the frame, the second surface positioned to lie in the first path to engage the first surface.

5. The child's vehicle of claim 4, wherein the latch includes an actuator movably coupled to the storage bin, the actuator including the first surface, the first surface moving in the first path when the actuator is in a latched orientation, the first surface moving in a second path when the actuator is in a released orientation.

6. The child's vehicle of claim 5, wherein the second surface is out of the first path when the first surface is in the released orientation.

7. The child's vehicle of claim 4, wherein the second surface is spaced from the first surface when the storage bin is in the storage orientation and the actuator is in the latched orientation to permit movement of the actuator between the latched orientation and the released orientation.

8. A tricycle comprising a frame, the frame including a fork supporting a front wheel to permit a user to steer the tricycle, the frame further including a rear wheel mount having opposite ends, a rear wheel rotatably coupled adjacent each end, a movable storage bin coupled to the frame adjacent the rear wheels, and a latch coupled to at least one of the frame and the storage bin to inhibit movement of the storage bin from a storage orientation.

9. The tricycle of claim 8, wherein the latch includes an actuator movably coupled to the storage bin to move relative to the storage bin between a latched orientation and a released orientation, the actuator including a first lobe configured to engage the storage bin to prevent movement of the actuator beyond the released orientation.

10. The tricycle of claim 9, wherein the actuator includes a second lobe configured to engage the storage bin to prevent movement of the actuator beyond the latched orientation.

11. The tricycle of claim 8, wherein the movable storage bin includes a floor and at least one side wall extending upward from the floor, the floor being movably coupled to the frame to permit relative pivoting movement of the movable storage bin and the frame.

12. The tricycle of claim 8, wherein the floor includes a bracket extending downwardly therefrom, the bracket including a bearing surface to engage the rear wheel mount to permit relative pivoting movement between the storage bin and the frame.

13. The tricycle of claim 11, wherein a collar extends around a portion of the rear wheel mount and is coupled to the floor to pivotally secure the storage bin to the rear wheel mount.

14. A child's vehicle comprising a frame, a seat coupled to the frame, wheels rotatably coupled to the frame, a storage bin coupled to the frame for movement relative thereto, and means for latching the storage bin in a storage orientation to inhibit movement of the storage bin from the storage orientation toward a dumping orientation.

15. The child's vehicle of claim 14, wherein the means for latching includes an actuator movably coupled to the storage bin, the actuator including a first surface that engages a second surface provided on the frame to releasably maintain the storage bin in the storage orientation.

16. The child's vehicle of claim 15, wherein the actuator includes a first surface and the means for latching includes a second surface coupled to the frame, the first surface moving in a first path about a portion of the frame upon movement of the storage between the storage orientation and dumping orientation, the second surface being positioned to lie in the first path to engage the first surface when the actuator is in a latched orientation.

17. The child's vehicle of claim 16, wherein the first surface moves in the first path when the actuator is in the latched orientation, the actuator being movable to a released orientation in which the first surface moves in a second path, and the actuator moves from the latched orientation to the released orientation in response to a lifting force applied by a user to the actuator.

18. The child's vehicle of claim 15, wherein the storage bin includes a floor and a front wall extending upwardly from the floor, the actuator being coupled to the front wall and at least a portion of the actuator positioned between the front wall and a portion of the frame.

19. The child's vehicle of claim 18, wherein the actuator includes a handle projecting from the front wall and away from the storage bin.

20. The child's vehicle of claim 14, wherein the means for latching is biased to a latched orientation.
